(19) United States
(12) Patent Application Publication
(10) Pub. No.: US 2017/0106789 A1
(43) Pub. Date: Apr. 20, 2017

(54) Alert Assembly

(71) Applicant: Catherine Holdbrook-Smith, Harbor City, CA (US)

(72) Inventor: Catherine Holdbrook-Smith, Harbor City, CA (US)

(21) Appl. No.: 14/883,092

(22) Filed: Oct. 14, 2015

(51) Int. Cl. B60Q 9/00; B60R 1/00; B60N 2/26

(52) U.S. Cl. CPC B60Q 9/00; B60N 2/26; B60R 1/00

(57) ABSTRACT

An alert assembly includes a base unit that may be coupled to a seatbelt in a vehicle such that the base unit is positioned against a child seated in the vehicle. Thus, the base unit detects sounds made by the child. A remote unit is provided that may be carried and the remote unit is in communication with the base unit. The remote unit emits the sounds made by the child such that a user is reminded that the child is in the vehicle.

### BACKGROUND OF THE DISCLOSURE

### Field of the Disclosure

The disclosure relates to alert devices and more particularly pertains to a new alert device for preventing a child from being inadvertently left in a vehicle.

### SUMMARY OF THE DISCLOSURE

An embodiment of the disclosure meets the needs presented above by generally comprising a base unit that may be coupled to a seatbelt in a vehicle such that the base unit is positioned against a child seated in the vehicle. Thus, the base unit detects sounds made by the child. A remote unit is provided that may be carried and the remote unit is in communication with the base unit. The remote unit emits the sounds made by the child such that a user is reminded that the child is in the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of an alert assembly according to an embodiment of the disclosure.

FIG. 2 is a back perspective view of an embodiment of the disclosure.

FIG. 3 is a schematic view of an embodiment of the disclosure.

FIG. 4 is a perspective in-use view of an embodiment of the disclosure.

FIG. 5 is a front perspective in-use view of an embodiment of the disclosure.

### DESCRIPTION OF THE PREFERRED EMBODIMENT

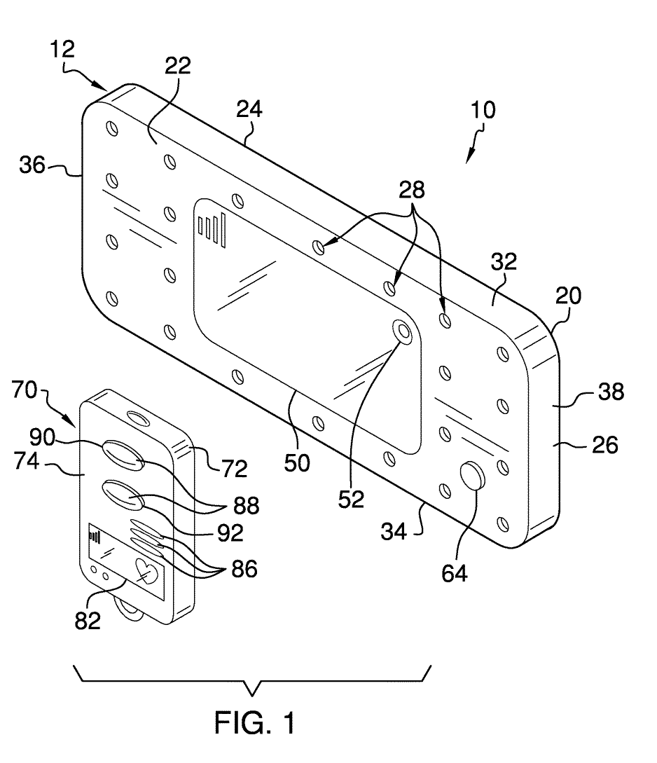

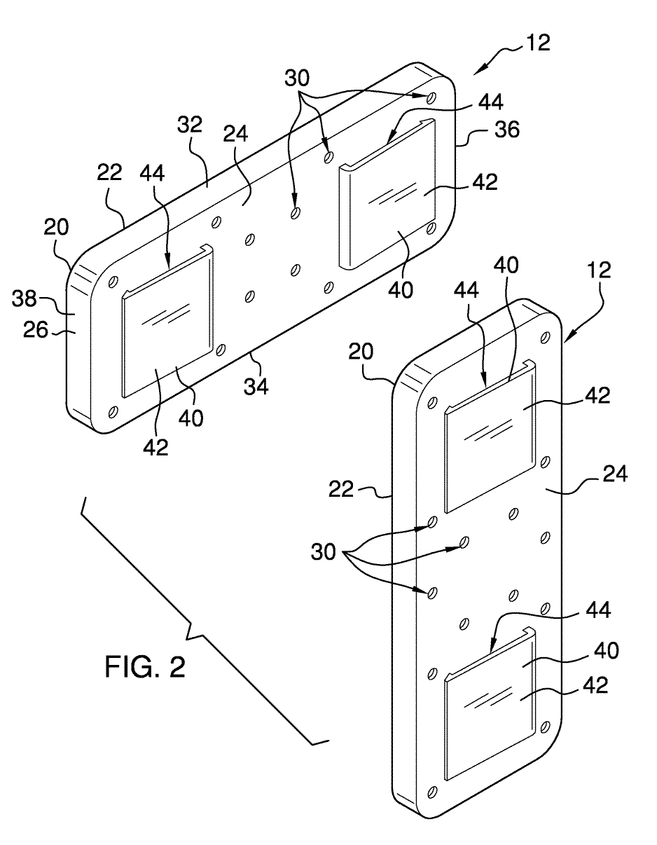

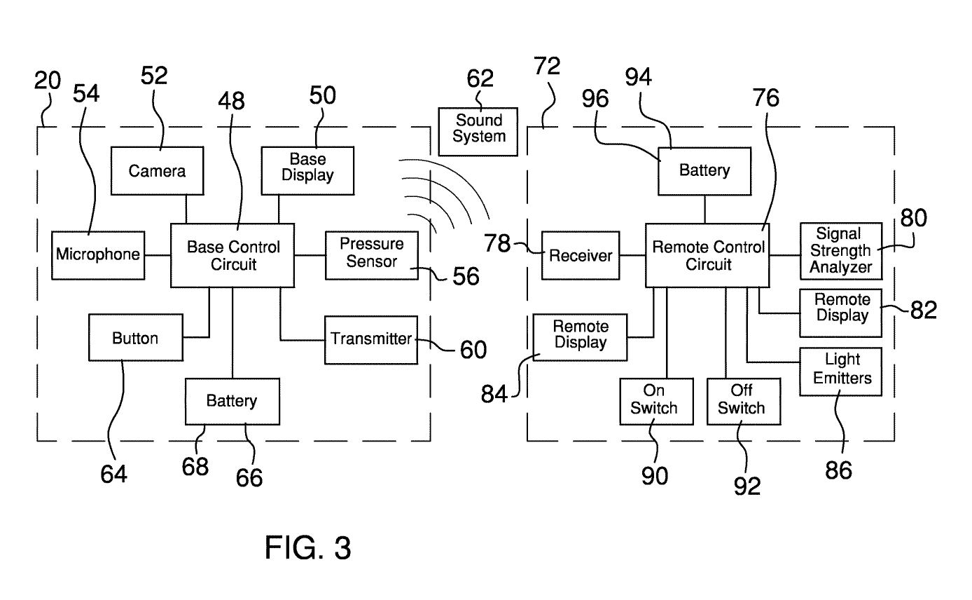

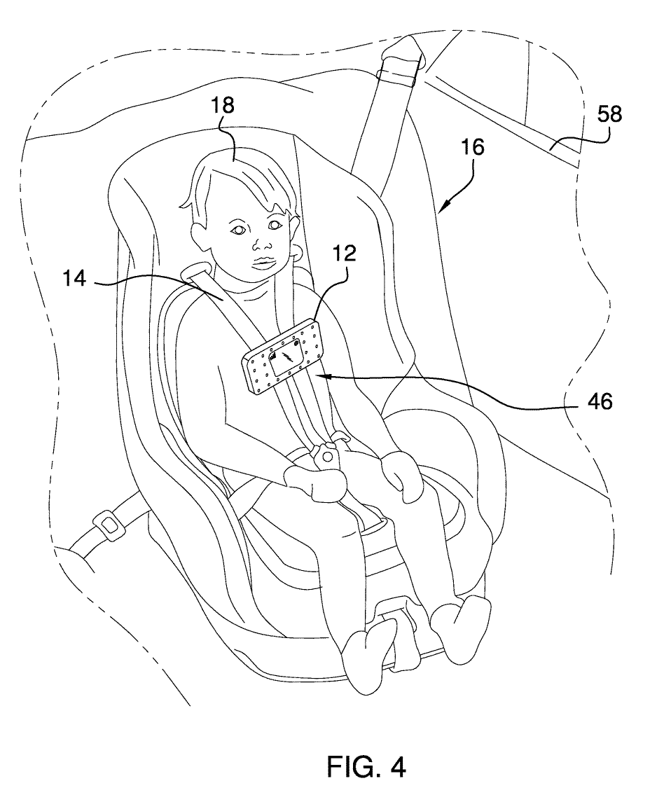

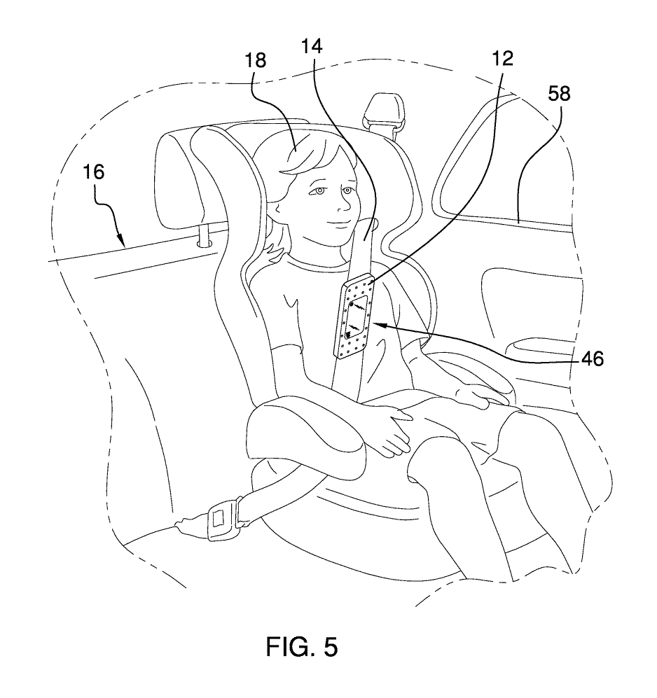

With reference now to the drawings, and in particular to FIGS. 1 through 5 thereof, a new alert device embodying the principles and concepts of an embodiment of the disclosure and generally designated by the reference numeral 10 will be described.

As best illustrated in FIGS. 1 through 5, the alert assembly 10 generally comprises a base unit 12 that may be coupled to a seatbelt 14 in a vehicle 16 such that the base unit 12 is positioned against a child 18 seated in the vehicle 16. The base unit 12 detects sounds made by the child 18 and the vehicle 16 may be a passenger vehicle or the like.

The base unit 12 comprises a base housing 20 that has a front side 22, a back side 24 and a peripheral edge 26 extending between the front side 22 and the back side 24. The front side 22 has a plurality of first openings 28 extending therethrough such that each of the first openings 28 captures sounds made by the child 18. The back side 24 has a plurality of second openings 30 extending therethrough such that each of the second openings 30 captures sounds made by the child 18. The peripheral edge 26 has a top side 32, a bottom side 34, a first lateral side 36 and a second lateral side 38.

A pair of retainers 40 is provided and each of the retainers 40 is coupled to the back side 24. Each of the retainers 40 has an outwardly facing side 42. The outwardly facing side 42 of each of the retainers 40 is spaced from the back side 24 to define a belt space 44 between the retainers 40 and the back side 24. Thus, the belt space 44 may insertably receive the seat belt 14 such that the back side 24 is positioned against a chest 46 of the child 18 thereby facilitating the plurality of first openings 28 to receive a sound of the child's 18 heartbeat and breathing. The belt space 44 in each retainer 40 may be aligned with the top side 32 and the bottom side 34 of the base housing 20 thereby facilitating the base housing 20 to be slidably coupled to a pair of the seatbelts 14. Alternatively, the belt space 44 in each retainer 40 may be aligned with the first lateral side 36 and the second lateral side 38 of the base housing 20. Thus, the base housing 20 may be slidably coupled to a single seatbelt 14.

A base control circuit 48 is positioned within the base housing 20 and a base display 50 is coupled to the front side 22. The base display 50 is electrically coupled to the base control circuit 48 and the base display 50 may be an LCD or the like. A camera 52 is coupled to the front side 22 such that the camera 52 may capture images. The camera 52 is electrically coupled to the base control circuit 48 and the camera 52 may be a digital camera or the like.

A microphone 54 is positioned within the base housing 20 such that the microphone 54 may detect the sounds captured by each of the first openings 28 and each of the second openings 30. The microphone 54 is electrically coupled to the base control circuit 48. A pressure sensor 56 is positioned within the base housing 20 such that the pressure sensor 56 detects atmospheric pressure within the vehicle 16. Thus, the pressure sensor 56 detects when a door 58 of the vehicle 16 has been opened and closed by detecting the resulting change in atmospheric pressure within the vehicle 16.

A transmitter 60 is positioned within the base housing 20 and the transmitter 60 is electrically coupled to the base control circuit 48. The transmitter 60 is in electrical communication with a sound system 62 of the vehicle 16 thereby facilitating the sound system 62 to emit the sound of the child's 18 heartbeat and breathing. The transmitter 60 may comprise a radio frequency transmitter or the like that utilizes a WPAN signal.

A button 64 is coupled to the front side 22 such that the button 64 may be manipulated. The button 64 is electrically coupled to said base control circuit 48 such that the button 64 turns the base control circuit 48 on and off. A base power supply 66 is positioned within the base housing 20 and the base power supply 66 is electrically coupled to the base control circuit 48. The base power supply 66 comprises at least one battery 68.

A remote unit 70 is provided that may be carried and the remote unit 70 is in communication with the base unit 12. The remote unit 70 emits the sounds made by the child 18 such that a user is reminded that the child 18 is in the vehicle 16. The remote unit 70 comprises a remote housing 72 that has a front side 74. A remote control circuit 76 is positioned within the remote housing 72 and a transceiver 78 is positioned within the remote housing 72.

The transceiver 78 is electrically coupled to the remote control circuit 76 and the transceiver 78 is in electrical communication with the transmitter 60. The transceiver 78 may be a radio frequency receiver that utilizes a WPAN signal and the remote control circuit 76 includes a signal strength analyzer 80. The signal strength analyzer 80 analyzes the strength of the signal from the transmitter 60 thereby facilitating the signal strength analyzer 80 to determine a distance between the remote unit 70 and the base unit 12. The remote unit 70 may alternatively comprise a smart phone, a key fob or other similar device. The remote unit 70 may be in electrical communication with an extrinsic electronic device such as a computer or the like.

A remote display 82 is positioned on the front side 74 and the remote display 82 is electrically coupled to the remote control circuit 76. The remote display 82 may comprise an LCD or the like and the remote display 82 may display a graph corresponding to the heartbeat of the child 18. A speaker 84 is coupled to the remote housing 72 and the speaker 84 is electrically coupled to the remote control circuit 76. The speaker 84 is actuated when the pressure sensor 56 detects the vehicle door 58 has been opened and closed and when the signal strength analyzer 80 determines the remote unit 70 has moved beyond a trigger distance from the base unit 12. The trigger distance may range between approximately ten feet and twenty feet. The speaker 84 emits the sounds made by the child 18 when the vehicle door 58 has been opened and closed and the trigger distance has been exceeded thereby facilitating the user to be reminded that the child 18 is in the vehicle 16.

A plurality of light emitters 86 is provided and each of the light emitters 86 is attached to the front side 74. Each of the light emitters 86 is electrically coupled to the remote control circuit 76. Thus, the light emitters 86 are actuated to emit light when the pressure sensor 56 detects the vehicle door 58 has been opened and closed and when the trigger distance between the remote unit 70 and the base unit 12 has been exceeded. Each of the light emitters 86 may comprise an LED or the like and the light emitters 86 remind the user that the child 18 is in the vehicle 16.

A pair of switches 88 is provided and each of the switches 88 is coupled to the remote housing 72 such that each of the switches 88 may be manipulated. Each of the switches 88 is electrically coupled to the remote control circuit 76 such that each of the switches 88 controls operational parameters of the remote unit 70. The pair of switches 88 may include an on switch 90 and an off switch 92. A remote power supply 94 is positioned within the remote housing 72. The remote power supply 94 is electrically coupled to the remote control circuit 76 and the remote power supply 94 comprises at least one battery 96.

In use, the base housing 20 is slidably coupled to the seatbelt 14 such that the back side 24 of the base housing 20 is positioned against the child's chest 46. The button 64 is manipulated to turn the base unit 12 on and the on switch 90 is manipulated on the remote unit 70. The speaker 84 emits the sound of the child's 18 breathing, heartbeat and other sounds made by the child 18 when the remote unit 70 is moved away from the base unit 12 a distance that exceeds the trigger distance. The remote unit 70 provides a reminder that the child 18 has been left unattended in the vehicle 16 thereby preventing the child 18 from being injured due to heat exposure or from suffering other adverse affects resulting from being left unattended in the vehicle 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An alert assembly configured to issue an alarm when a child is inadvertently left in a vehicle, said assembly comprising:
a base unit configured to be coupled to a seatbelt in a vehicle such that said base unit is positioned against a child seated in the vehicle, said base unit being configured to detect sounds made by the child; and
a remote unit configured to be carried, said remote unit being in communication with said base unit, said remote unit being configured to emit the sounds made by the child such that a user is reminded that the child is in the vehicle.

2. The assembly according to claim 1, wherein said base unit comprises a base housing having a front side, a back side and a peripheral edge extending between said front side and said back side, said front side having a plurality of first openings extending therethrough wherein each of said first openings is configured to capture sounds made by the child, said back side having a plurality of second openings extending therethrough wherein each of said second openings is configured to capture sounds made by the child.

3. The assembly according to claim 2, further comprising a pair of retainers, each of said retainers being coupled to said back side, each of said retainers having a outwardly facing side, said outwardly facing side of each of said retainers being spaced from said back side to define a belt space between said retainers and said back side wherein said belt space is configured to insertably receive the seat belt such that said back side is positioned against a chest of the child thereby facilitating said plurality of first openings to receive a sound of the child's heartbeat and breathing.

4. The assembly according to claim 1, wherein said base unit further comprises:
a housing having a front side;
a base control circuit being positioned within said base housing; and
a base display being coupled to said front side, said base display being electrically coupled to said base control circuit.

5. The assembly according to claim 4, further comprising:
a camera being coupled to said front side wherein said camera is configured to capture images, said camera being electrically coupled to said base control circuit; and
a microphone being positioned within said base housing wherein said microphone is configured to detect the sounds captured by said each of said first openings and each of said second openings, said microphone being electrically coupled to said base control circuit.

6. The assembly according to claim 4, further comprising:
a pressure sensor being positioned within said base housing wherein said pressure sensor is configured to detect atmospheric pressure within the vehicle thereby facilitating said pressure sensor to detect when a door of the vehicle has been opened and closed; and
a transmitter being positioned within said base housing, said transmitter being electrically coupled to said base control circuit, said transmitter being configured to be in electrical communication with a sound system of the vehicle thereby facilitating the sound system to emit the sound of the child's heartbeat and breathing.

7. The assembly according to claim 4, further comprising:
a button being coupled to said front side wherein said button is configured to be manipulated, said button being electrically coupled to said base control circuit such that said button turns said base control circuit on and off; and
a base power supply being positioned within said base housing, said base power supply being electrically coupled to said base control circuit, said base power supply comprising at least one battery.

8. The assembly according to claim 1, wherein said remote unit comprises:
a remote housing having a front side; and
a remote control circuit being positioned within said remote housing.

9. The assembly according to claim 8, further comprising:
a transceiver being positioned within said remote housing, said transceiver being electrically coupled to said remote control circuit, said transceiver being in electrical communication with said transmitter; and
a remote display being positioned on said front side, said remote display being electrically coupled to said remote control circuit.

10. The assembly according to claim 8, further comprising a speaker being coupled to said remote housing, said speaker being electrically coupled to said remote control circuit such that said speaker is actuated when a pressure sensor detects a vehicle door has been opened and closed, said speaker being configured to emit the sounds made by the child when the vehicle door has been opened and closed thereby facilitating the user to be reminded that the child is in the vehicle.

11. The assembly according to claim 8, further comprising a plurality of light emitters, each of said light emitters being attached to said front side, each of said light emitters being electrically coupled to said remote control circuit such that said light emitters are actuated to emit light when a pressure sensor detects a vehicle door has been opened and closed wherein said light emitters are configured to remind the user that the child is in the vehicle.

12. The assembly according to claim 8, further comprising:
a pair of switches, each of said switches being coupled to said remote housing wherein each of said switches is configured to be manipulated, each of said switches being electrically coupled to said remote control circuit such that each of said switches controls operational parameters of said remote unit; and
a remote power supply being positioned within said remote housing, said remote power supply being electrically coupled to said remote control circuit, said remote power supply comprising at least one battery.

13. An alert assembly configured to issue an alarm when a child is inadvertently left in a vehicle, said assembly comprising:
a base unit configured to be coupled to a seatbelt in a vehicle such that said base unit is positioned against a child seated in the vehicle, said base unit being configured to detect sounds made by the child, said base unit comprising:
a base housing having a front side, a back side and a peripheral edge extending between said front side and said back side, said front side having a plurality of first openings extending therethrough wherein each of said first openings is configured to capture sounds made by the child, said back side having a plurality of second openings extending therethrough wherein each of said second openings is configured to capture sounds made by the child,
a pair of retainers, each of said retainers being coupled to said back side, each of said retainers having a outwardly facing side, said outwardly facing side of each of said retainers being spaced from said back side to define a belt space between said retainers and said back side wherein said belt space is configured to insertably receive the seat belt such that said back side is positioned against a chest of the child thereby facilitating said plurality of first openings to receive a sound of the child's heartbeat and breathing,
a base control circuit being positioned within said base housing,
a base display being coupled to said front side, said base display being electrically coupled to said base control circuit,
a camera being coupled to said front side wherein said camera is configured to capture images, said camera being electrically coupled to said base control circuit,
a microphone being positioned within said base housing wherein said microphone is configured to detect the sounds captured by said each of said first openings and each of said second openings, said microphone being electrically coupled to said base control circuit,
a pressure sensor being positioned within said base housing wherein said pressure sensor is configured to detect atmospheric pressure within the vehicle thereby facilitating said pressure sensor to detect when a door of the vehicle has been opened and closed,
a transmitter being positioned within said base housing, said transmitter being electrically coupled to said base control circuit, said transmitter being configured to be in electrical communication with a sound system of the vehicle thereby facilitating the sound system to emit the sound of the child's heartbeat and breathing,
a button being coupled to said front side wherein said button is configured to be manipulated, said button being electrically coupled to said base control circuit such that said button turns said base control circuit on and off; and
a base power supply being positioned within said base housing, said base power supply being electrically coupled to said base control circuit, said base power supply comprising at least one battery; and
a remote unit configured to be carried, said remote unit being in communication with said base unit, said remote unit being configured to emit the sounds made by the child such that a user is reminded that the child is in the vehicle, said remote unit comprising:
a remote housing having a front side,
a remote control circuit being positioned within said remote housing,
a transceiver being positioned within said remote housing, said transceiver being electrically coupled to said remote control circuit, said transceiver being in electrical communication with said transmitter,
a remote display being positioned on said front side, said remote display being electrically coupled to said remote control circuit,
a speaker being coupled to said remote housing, said speaker being electrically coupled to said remote control circuit such that said speaker is actuated when said pressure sensor detects the vehicle door has been opened and closed, said speaker being configured to emit the sounds made by the child when the vehicle door has been opened and closed thereby facilitating the user to be reminded that the child is in the vehicle,
a plurality of light emitters, each of said light emitters being attached to said front side, each of said light emitters being electrically coupled to said remote control circuit such that said light emitters are actuated to emit light when said pressure sensor detects the vehicle door has been opened and closed wherein said light emitters are configured to remind the user that the child is in the vehicle,
a pair of switches, each of said switches being coupled to said remote housing wherein each of said switches is configured to be manipulated, each of said switches being electrically coupled to said remote control circuit such that each of said switches controls operational parameters of said remote unit, and
a remote power supply being positioned within said remote housing, said remote power supply being electrically coupled to said remote control circuit, said remote power supply comprising at least one battery.
